(19) United States
(12) Patent Application Publication
(10) Pub. No.: US 2015/0310375 A1
(43) Pub. Date: Oct. 29, 2015

(54) INDIVIDUAL PRODUCTIVITY MEASUREMENT

(71) Applicant: Infosys Limited, Bangalore (IN)

(72) Inventors: Jayeeta Dutta, Bangalore (IN); Nishikant Nigam, Bangalore (IN); Pandiya Kumar Rajamony, Bangalore (IN); Rohan Narayan Murty, Bangalore (IN); Satyajit Mohanty, Bhubaneswar (IN); Shameek Dutta, Bangalore (IN); Shishank Gupta, Bangalore (IN); Sunil Kumar Gupta, Bangalore (IN)

(73) Assignee: Infosys Limited, Bangalore (IN)

(21) Appl. No.: 14/683,011

(22) Filed: Apr. 9, 2015

(30) Foreign Application Priority Data
Apr. 28, 2014 (IN) 2120/CHE/2014

(51) Int. Cl. G06Q 10/06

(52) U.S. Cl. CPC G06Q 10/06398

(57) ABSTRACT

A computer implemented method of individual productivity measurement includes capturing a work output of an individual and tracking a net effort of the individual. Further, the method includes computing an individual productivity of the individual, calculating a mean of individual productivities of the individuals associated with a work sub-group, and defining one or more ranges of the individual productivities in the work sub-group. The individual productivity is compared with one of the mean and the one or more ranges.

### FIELD OF TECHNOLOGY

The field of technology relates to a method, system and/or apparatus for measuring individual productivity.

### BACKGROUND

An organization requires employees to perform at optimal capacity to reach the organization's objectives. Also, the organization requires the employees to continuously improve productivity. Systems and methods that are available to measure employee performance are generic. However, performance measures of employees in different domains may vary with the domains and/or streams.

Employees working in the organization need to better understand performance needs that the organization requires from the employees. Rarely do employees know how to improve work habits that lead to higher productivity. Managers handling teams of employees may not have insights that would help the managers identify and nurture best performing talent. Current feedback and employee evaluation systems have inherent insufficiencies to provide mechanisms and insights to empower decision makers with data to compare performance with best in the class and subsequently plan for improvements.

### SUMMARY

Disclosed are a method, an apparatus and/or a system of measuring individual productivity.

In one aspect of the present invention, a computer implemented method of individual productivity measurement includes defining and capturing a work output of an individual and tracking a net effort of the individual. Further, the method includes computing an individual productivity of the individual, calculating a mean of individual productivities of the individuals associated with a work sub-group, and defining one or more ranges of the individual productivities in the work sub-group. Thereafter, the individual productivity is compared with one of the mean and the one or more ranges.

In another aspect of the present invention, a system of individual productivity measurement includes one or more processors, a computer readable storage medium communicatively coupled to an input device and one or more programs. The one or more programs are stored in the computer readable storage medium and configured to be executed by the one or more processors. The programs include instructions for capturing a work output of an individual and instructions for tracking a net effort of the individual. Further, the programs include instructions for computing an individual productivity of the individual, instructions for calculating a mean of individual productivities of the individuals in a work sub-group and instructions for defining one or more ranges of the individual productivities in the work sub-group. Also, the programs include instructions for comparing the individual productivity of the individual with one of the mean and the one or more ranges.

In yet another aspect of the present invention, a non-transitory computer readable medium having stored thereon instructions for individual productivity measurement, which, when executed by one or more processors, causes the processors to perform a set of steps. The set of steps include capturing a work output of an individual associated and tracking a net effort of the individual. Further, the set of steps include computing an individual productivity of the individual, calculating a mean of individual productivities of the individuals associated with a work sub-group, and defining one or more ranges of the individual productivities in the work sub-group. The set of steps further includes comparing the individual productivity with one of the mean and the one or more ranges.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a dashboard detailing the individual productivity measures of employees and the employees' variation from the mean, according to one or more embodiments.

FIG. 2 is a diagrammatic representation of a data processing system capable of processing a set of instructions to perform any one or more of the methodologies herein, according to one embodiment.

FIG. 3 is a process flow diagram detailing the operations of a method of calculating an individual productivity measure, according to one or more embodiments.

FIG. 4 is a representation of individual productivity computation, according to one embodiment.

Other features of the present embodiments will be apparent from the accompanying drawings and from the detailed description that follows.

### DETAILED DESCRIPTION

Example embodiments, as described below, may be used to provide a method, an apparatus and/or a system of measuring individual productivity. Although the present embodiments have been described with reference to specific example embodiments, it will be evident that various modifications and changes may be made to these embodiments without departing from the broader spirit and scope of the various embodiments.

In one or more embodiments, an organization may want employees to continuously improve productivity and output in line with time and increasing experience and the organization's needs to be dynamic rather than static.

Methods seen in the past have been at levels that are abstract and irrelevant to specific work of an employee. The methods may no longer be effective for continuous improvement and quantum improvements that business may be seeking in the current scenario.

In one or more embodiments, employees may need to have better realization of improving performance needs in context of a business and an organization needs. Further, employees may not have mechanisms to obtain deeper insights on employees' work habits, tools and techniques used, available knowledge management systems that provides the employees guidance on how and where to improve.

Still further, managers may also carry high level insights in the performance of the employees and managers may lack a framework that provides managers deeper and objective assessment of the employees' performance in a standalone manner and in a comparative manner.

In one or more embodiments, individual productivity may be measured in an information technology (IT) organization wherein the IT organization may apply computers and telecommunications equipment to store, retrieve and handle data in the context of a business. Further, the IT organization may be engaged in a business of one of computer hardware, software, electronics, semiconductors, internet, telecom equipment, e-commerce and computer services

In one or more embodiments, disclosed here is a method of individual productivity measurement may include measuring an individual's output, collecting measurements of individuals from various streams, analyzing the collected data to build a model specific to the stream, calculating a mean of the productivity measurements of individuals in the stream and comparing the individual's productivity to the mean. Further, as a result of the comparison performance brackets may be defined. In an example embodiment, the performance brackets may classify the individuals of the stream into top tier, middle tier and a bottom tier.

In one or more embodiments, the stream may be an area of work not limited to software testing, software development, analysis work, infrastructure management, technical support services, software maintenance etc. In one or more embodiments, employees of an organization may be classified into various streams. Classification of employees into streams may have many reasons including but not limited to improved efficiency and clearer objectives.

In an example embodiment, an organization may have defined job levels that employees of the organization fall under. Individual productivity may be calculated for select job levels decided by managers and/or management team. In an example embodiment, job levels may map to specific job descriptions as per a human resource system. The human resource system may be a system within an organization that stores details associated with employees of an organization.

In one or more embodiments, a ticket may be a request for a service. In an example embodiment, infrastructure management services may be delivered through tickets. Further, tickets may be of different types including but not limited to an incident, problem, service request, event and change. In an organization that may offer services through tickets resolution, each client of the organization may have client specific tools through which the tickets may be generated, maintained and resolved. A complexity of each ticket may be recorded based on the type of ticket. After recording complexity of the ticket, the ticket may be classified based on a level of complexity. For example, the level of complexity may be one of simple, medium and complex. The classification of tickets may be based on a complexity required to execute the ticket. Simple tickets may be resolved through pre-defined procedure documents. Medium tickets may be resolved after about 50% changes to pre-defined procedure documents. Complex tickets may be ones for which there are no pre-defined procedure documents available.

Based on the time taken for the ticket a total time for the ticket may be calculated after deducting a wait time from the time taken. The wait time may be an amount time spent on the ticket that is beyond the control of the employee. For example, the wait time may include, but not limited to, time taken by a vendor to fix breaks and resolves dependencies, inter-stream dependencies, time spent in waiting for clarification from an end user, higher priority tickets being pushed into a queue that the employee has to be working on, employee induced breaks and so on.

Therefore, resolution time of the ticket with respect to the employee may be a difference of total time elapsed and the wait time.

Resolution time=total time elapsed−wait time

Further, for example, an employee working on the ticket may use one of a start, clarification and/or stop functionalities in the ticketing tool to track the wait time.

Based on a historical analysis of the resolution time of tickets, an average time may be calculated for each of the classifications under the different types of tickets. For example, for a simple ticket under the incident type of ticket, the resolution time average may be 20 minutes.

The time taken for the tickets may be normalized. For example, the normalization may be based on utilizing the incident type of ticket under the simple classification as a base unit. Data may be captured for each of the employees working on the tickets under a stream. The data captured may be uploaded onto a work bench that accommodates various job roles such as project manager, delivery manager, project point of contact, and account quality manager.

A mean may be calculated for every classification under the different types of tickets. The mean time may be calculated using the data captured at every job level. Further, a work unit conversion ratio that indicates a variation from the mean may be calculated to define the range of variation of an employee's performance from the mean of the job level under the stream. An individual productivity measure may be calculated based on the mean time. The individual productivity measure may be normalized to units of work per hour.

Employees of an organization may be provided access to a dashboard. The dashboard may display data associated with the individual productivity measure of the employee and/or individual productivity of other employees. The display data may depend on the job level of the employee accessing the dashboard.

In an example embodiment, the manager may be provided with an access to a dashboard that displays names of various employees reporting to the manager with values of individual productivity measures and variations from the mean against the names of the employees. The dashboard may help the manager gain insights such as number of employees in the manager's team who are below the mean of the stream, the best performers in the team, and so on. Further, employees may be provided with an access to dashboards based on the job level of the employee. For example, an employee the lowest level may see a dashboard providing details of the employee's productivity measure, a variation from the mean of the stream and where the employee is placed as a performer with respect to the performance of the employee's peers.

In one or more embodiments, a dashboard may include a display of computation of individual productivity and trends in individual productivity measurements.

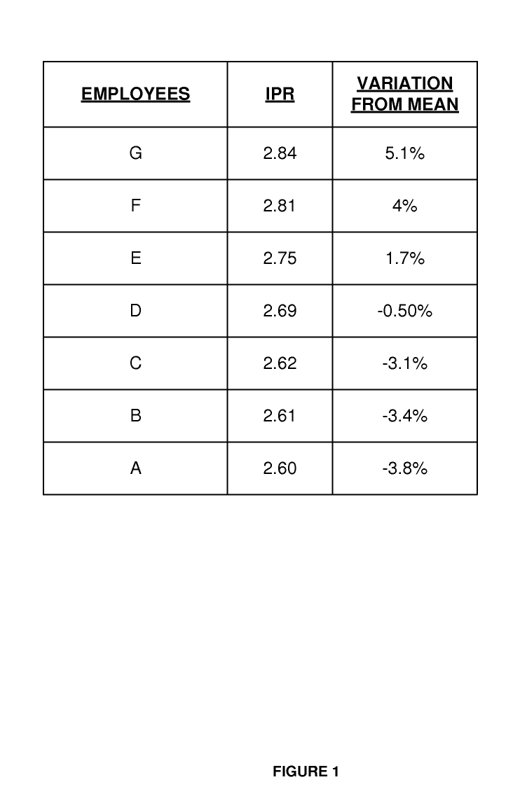

FIG. 1 is a schematic view of a dashboard, according to an example embodiment. In an organization, multiple employees may be reporting to a manager. Each manager may be shown an individual productivity measure and a variation from the mean for each of the said multiple employees reporting to the manager. The variation from the mean may be a difference of an employee's performance in comparison to the mean performance of the employees in a stream. For example, the difference may be expressed in terms of a percentage and/or fraction.

The individual productivity measure may be calculated based on a computer implemented method that may include capturing, through a processor associated with a computer network, a work output of an individual. The captured work output may be associated with a model linked to a work sub-group. The method may further include tracking, through the processor, a net effort of the individual. The method may also include computing, an individual productivity, a mean of individual productivities of individuals in the work sub-group and a top range of the individual productivities in the work sub-group. Based on the computation, the individual productivity may be compared with one of the mean and the top range.

In one or more embodiments, the comparison may be published onto a user interface.

FIG. 1 shows a schematic view of individual productivities of employees A to G. Also, FIG. 1 shows the variation from the mean performance of the employees A to G in the stream. Based on the schematic view a manager of the employees A to G may be able to ascertain means for team optimization, better skill management and for competence mapping in addition to ascertaining the performance level of employees A to G. Further, the manager may be able to identify best performers out of the employees A to G that report to the manager.

In one embodiment, a system of individual productivity measurement may include one or more processors, a computer readable storage medium communicatively coupled to an input device and one or more programs. The one or more programs are stored in the computer readable storage medium and configured to be executed by the one or more processors. The programs may include instructions for capturing a work output of an individual and instructions for tracking a net effort of the individual. Further, the programs may include instructions for computing an individual productivity of the individual, instructions for calculating a mean of individual productivities of the individuals in the work sub-group and instructions for defining one or more ranges of the individual productivities in the work sub-group. Also, the programs may include instructions for comparing the individual productivity with one of the mean and the one or more ranges. In one or more embodiments, the work sub-group may be a group of employees having similar responsibilities such as a set of application developers.

In another embodiment, a non-transitory computer readable medium having stored thereon instructions for individual productivity measurement, which, when executed by one or more processors, may cause the processors to perform a set of steps. The set of steps may include capturing a work output of an individual and tracking a net effort of the individual. Further, the set of steps may include computing an individual productivity of the individual, calculating a mean of individual productivities of the individuals working in work sub-group, and defining one or more ranges of the individual productivities in the work sub-group. The set of steps may further include comparing the individual productivity with one of the mean and the one or more ranges.

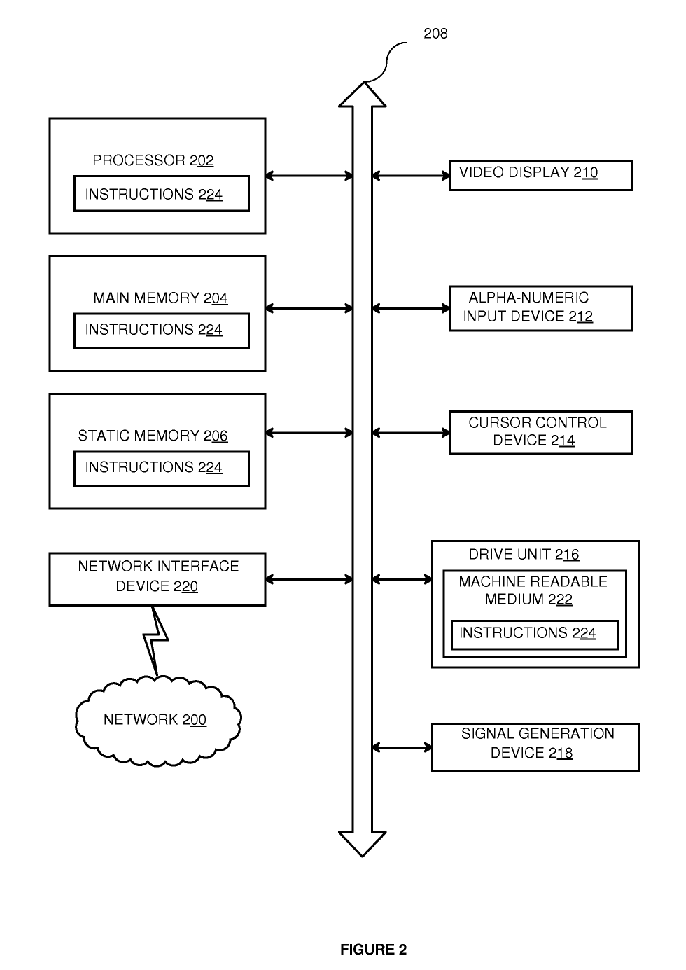

FIG. 2 is a diagrammatic representation of a data processing system capable of processing a set of instructions to perform any one or more of the methodologies herein, according to an example embodiment. FIG. 2 shows a diagrammatic representation of machine in the example form of a computer system 200 within which a set of instructions, for causing the machine to perform any one or more of the methodologies discussed herein, may be executed. In various embodiments, the machine operates as a standalone device and/or may be connected (e.g., networked) to other machines.

In a networked deployment, the machine may operate in the capacity of a server and/or a client machine in server-client network environment, and or as a peer machine in a peer-to-peer (or distributed) network environment. The machine may be a personal-computer (PC), a tablet PC, a set-top box (STB), a Personal Digital Assistant (PDA), a cellular telephone, a web appliance, a network router, switch and or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 200 includes a processor 202 (e.g., a central processing unit (CPU) a graphics processing unit (GPU) and/or both), a main memory 204 and a static memory 206, which communicate with each other via a bus 208. The computer system 200 may further include a video display unit 210 (e.g., a liquid crystal displays (LCD) and/or a cathode ray tube (CRT)). The computer system 200 also includes an alphanumeric input device 212 (e.g., a keyboard), a cursor control device 214 (e.g., a mouse), a disk drive unit 216, a signal generation device 218 (e.g., a speaker) and a network interface device 220.

The disk drive unit 216 includes a machine-readable medium 222 on which is stored one or more sets of instructions 224 (e.g., software) embodying any one or more of the methodologies and/or functions described herein. The instructions 224 may also reside, completely and/or at least partially, within the main memory 204 and/or within the processor 202 during execution thereof by the computer system 200, the main memory 204 and the processor 202 also constituting machine-readable media.

The instructions 224 may further be transmitted and/or received over a network 226 via the network interface device 220. While the machine-readable medium 222 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

In one or more embodiments, a computer implemented method of individual productivity measurement may include capturing a work output of an individual and tracking a net effort of the individual. Further, the method may include computing an individual productivity of the individual, calculating a mean of individual productivities of the individuals associated with the work sub-group, and defining one or more ranges of the individual productivities in the work sub-group. The individual productivity may be compared with one of the mean and the one or more ranges.

In an example embodiment, the work output of an individual may be captured as number of files completed, transactions executed, tickets completed and so on. In another example embodiment, the net effort of the individual may be tracked in hours, minutes, seconds, days, months, years and/or another known means of tracking time. A set of limits for the one or more ranges may be defined by a user.

In one or more embodiments, individual productivity of an individual may be calculated. The calculation may be based on work output and/or effort by the individual. One or more quality measures may be defined in an organization. The quality measures may be defined to keep a check on the quality of a work product delivered by the individual and/or a pre-defined group of individuals associated with the organization. The individual productivity calculated might be adjusted with the quality measures to provide adjusted productivity. The adjustment in individual productivity may be a factor of the quality measures.

In one or more embodiments, the captured work output may be associated with a model linked to the work sub-group. The model linked to the work sub-group may be associated with a pre-defined set of parameters. The parameters may be varied based on requirements of the work sub-group. For example, a work sub-group that has primary motives of infrastructure management may set parameters with tickets as a unit of measurement.

In one or more embodiments, a comparison between the individual productivity measurement and the mean and/or the one or more ranges may be published onto a user dashboard. The user dashboard may display the comparison and/or the individual productivity measurement as representations of data that include but are not limited to one of graph, list, table, chart, map, picture, and pictogram.

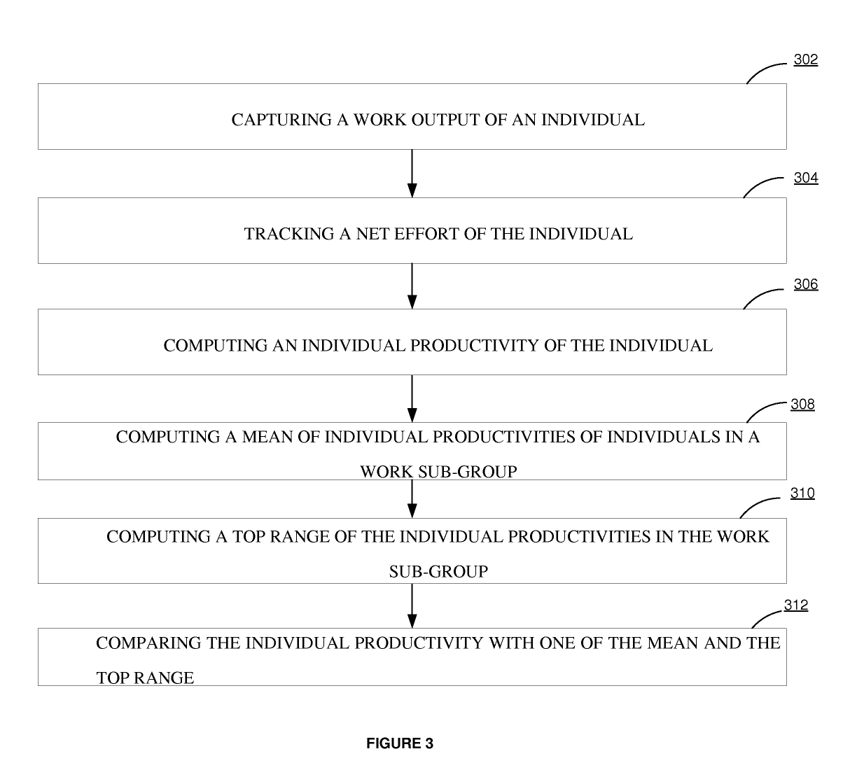

FIG. 3 is a process flow diagram detailing the operations of a method calculating an individual productivity measure, according to one embodiment. A method calculating an individual productivity measure may include capturing, through a processor associated with a computer network, a work output of an individual 302. The captured work output may be associated with a model linked to a work sub-group, wherein the work sub-group may be a group of individuals working for an organization having similar duties and responsibilities. The method may further include tracking, through the processor, a net effort of the individual 304. The method may also include computing, an individual productivity 306, a mean of individual productivities of individuals in the work sub-group 308 and a top range of the individual productivities in the work sub-group 310. Based on the computation, the individual productivity may be compared with one of the mean and the top range 312.

In one or more embodiments, a manager may use individual productivity measurements to one of understand a productivity level of employees reporting to the manager, plan quantitative feedback for a team reporting to the manager, revisit strategies for improvement, plan focused training for individuals, improving estimations, regularly recognize high performance within the team, and effectively manage staffing from available resources.

In an example embodiment, individual productivity may be measured in an application development environment. Requirements of an application may be broken down into transactions. An estimation size and effort may be made for each of the transactions. A work breakdown structure may be created for the transaction. The transaction may be allocated to an individual. An automated sizing platform may be created. The automated sizing platform may determine a size of the transaction in terms of a function point. A function point may be a unit of measurement to express an amount of business functionality an information system provides to the individual.

Further, a transaction quality and complexity of the application may be calculated based on the transactions that are part of the application.

Thus, an individual productivity measure may be calculated with inputs on amount of time spent, the size of the transaction, transaction quality factor and complexity factor.

Individual productivity measure=(size of the transaction(in function point)*transaction quality*complexity factor)/(Input effort(in hours))

wherein the transaction quality may be a composite index of violations and complexity factor may be based on product quality factors measured using product quality metrics. In one or more embodiments, the product quality metrics may change. The size of the transaction may be an actual size that is measured when the transaction takes places as opposed to an estimate of the size of the transaction.

Therefore, a manager of a team working on the application development may see dashboards including but not limited to comparing individual productivity measures against a mean of individual productivities for an application development stream, overall individual productivity measure ranges for the team, and project level average of individual productivity.

Additionally, an individual may be able to see the individual's productivity measure as a comparison against peers in the application development stream and/or in the team.

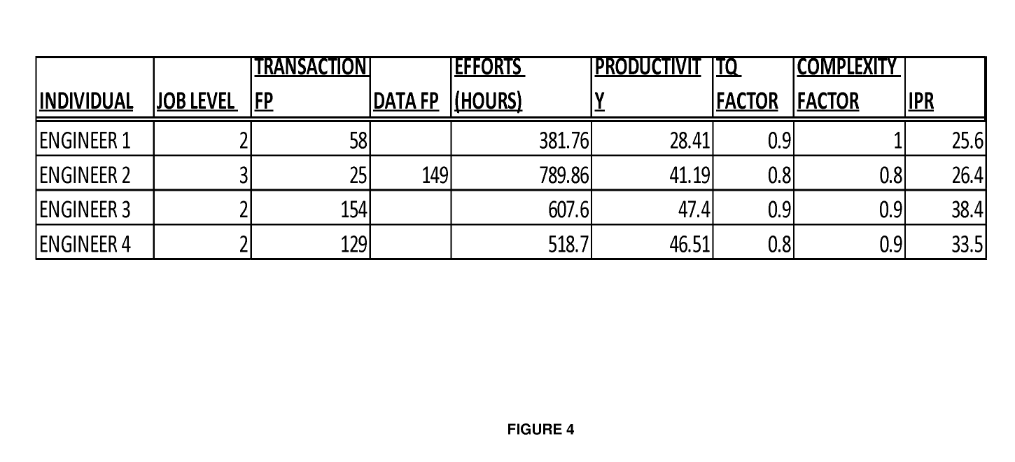

FIG. 4 is a representation of individual productivity computation, according to one embodiment. In an example embodiment, individuals Engineer 1-4 may be of different job levels such as job level 2 or job level 3. A transaction function point may be calculated for each of the Engineers 1-4. Further, a data function point may be added to the transaction function points of each of the Engineers 1-4. The data function point may be a multiple of data involved in transactions the individual is working on. A total function point may be calculated as a summation of transaction function point (FP) for each of the Engineers 1-4 and Data FP. A total effort may be tracked for the individual. A transaction quality (TQ) factor may also be calculated for the effort of the individual. The TQ factor may be a composite index based on violations such as performance, security, robustness that are modelled based on data available in a dashboard for a stream. A complexity factor may be calculated for the individual. The complexity factor may be product quality factor dependent on factors such as conditional complexity, SQL complexity, coupling, documentation ratio etc. that the individual associated with through transactions. Individual productivity computation through a model that may be defined for the stream.

In one or more embodiments, an overall individual productivity (IPR) may be calculated to arrive at one single IPR number for an individual working on different service catalogues and/or different services within a catalogue. The overall IPR for an individual may be calculated using a weighted average of deviation from mean and may be weighted based on percentage net effort spent in each service scope for which the individual delivers work output. Therefore, a uniformity may be achieved in arriving at a final IPR for individuals working across services due to multiple skillsets, business needs and competency development.

Advantages of the system of individual productivity measurement may include providing a quantitative way to understand an individual's contribution in a team. The system may help employees understand a performance level of the employees' immediate peers in the team and/or within a stream. The performance level may help in seeking specific advice, plan for training, enablement and create a personal development plan to match best performers in the team and/or the stream. Leveraging individual productivity dashboards, individuals may be able to introspect on the employees' performance levels and initiate self-improvement plans. Better performance may lead to better results and employee morale, recognition and growth.

Some advantages of the system may include, strategically developing and nurturing top talent in an environment of rapidly changing business demands. The system may also lead to build organization wide culture of change in work discipline and processes. Leadership team and managers may be able to leverage the measurement dashboards for effective execution of interventions, build an individual orientation for improvements and leverage the individual orientation as a real differentiator from competitors.

Further, advantages of the system may include helping customers in saving the customers time and money in a service environment. Further, helping the customers meet and exceed the customers' business objectives.

The method and systems disclosed herein may be used in several environments not limited to software testing, application maintenance, application development, infrastructure management services, and human resource management.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer devices), and may be performed in any order (e.g., including using means for achieving the various operations). Various operations discussed above may be tangibly embodied on a medium readable through the retail and/or an organization portal to perform functions through operations on input and generation of output. These input and output operations may be performed by a processor. The medium readable through the retail portal may be, for example, a memory, a transportable medium such as a CD, a DVD, a Blu-ray™ disc, a floppy disk, or a diskette. A computer program embodying the aspects of the exemplary embodiments may be loaded onto the retail portal. The computer program is not limited to specific embodiments discussed above, and may, for example, be implemented in an operating system, an application program, a foreground or background process, a driver, a network stack or any combination thereof. The computer program may be executed on a single computer processor or multiple computer processors.

Accordingly, the specification and drawings are to be regarded in an illustrative rather than a restrictive sense.

What is claimed is:

1. A computer implemented method of individual productivity measurement comprising:
capturing, through a processor associated with a computer network, a work output of an individual;
tracking, through the processor, a net effort of the individual;
computing, through the processor, an individual productivity of the individual;
calculating, through the processor, a mean of individual productivities of the individuals associated with a work sub-group;
defining, through the processor, at least one range of the individual productivities in the work sub-group; and
comparing, through the processor, the individual productivity with at least one of the mean and the at least one range.

2. The computer implemented method of claim 1, wherein the captured work output is associated with a model linked to the work sub-group.

3. The computer implemented method of claim 2, wherein the model linked to the work sub-group is associated with a pre-defined set of parameters.

4. The computer implemented method of claim 3, wherein the parameters are varied based on requirements of the work sub-group.

5. The computer implemented method of claim 1, further comprising: publishing, through the processor, the comparison onto a user dashboard.

6. The computer implemented method of claim 5, wherein displaying, on the user dashboard, the individual productivity measurement as at least one of graph, list, table, chart, map, picture, and pictogram.

7. A system of individual productivity measurement comprising:
one or more processors;
a computer readable storage medium communicatively coupled to an input device; and
one or more programs, wherein the one or more programs are stored in the computer readable storage medium and configured to be executed by the one or more processors, the programs including:
instructions for capturing, through the one or more processors associated with a computer network, a work output of an individual,
instructions for tracking, through the one or more processors, a net effort of the individual;
instructions for computing, through the one or more processors, an individual productivity of the individual;
instructions for calculating, through the one or more processors, a mean of individual productivities of the individuals in the work sub-group;
instructions for defining, through the one or more processors, at least one range of the individual productivities in the work sub-group; and
instructions for comparing, through the one or more processors, the individual productivity with at least one of the mean and the at least one range.

8. The system of claim 7, wherein the work output of the individual is captured through the input device.

9. The system of claim 7, wherein the captured work output is associated with a model linked to the work sub-group.

10. The system of claim 9, wherein the model linked to the work sub-group is associated with a pre-defined set of parameters.

11. The system of claim 10, wherein the parameters are varied based on requirements of the work sub-group.

12. The system of claim 7, wherein the comparison is published onto a user dashboard through the one or more processors.

13. The system of claim 12, wherein the user dashboard displays the individual productivity measurement as at least one of graph, list, table, chart, map, picture, or pictogram.

14. A non-transitory computer readable medium having stored thereon instructions for individual productivity measurement, which, when executed by at least one processor, causes the processor to perform steps comprising:
capturing, through the processor associated with a computer network, a work output of an individual;
tracking, through the processor, a net effort of the individual;
computing, through the processor, an individual productivity of the individual;
calculating, through the processor, a mean of individual productivities of the individuals in the work sub-group;
defining, through the processor, at least one range of the individual productivities in the work sub-group; and
comparing, through the processor, the individual productivity with at least one of the mean and the at least one range.

15. The medium as in claim 14, wherein the captured work output is associated with a model linked to the work sub-group.

16. The medium as in claim 15, wherein the model linked to the work sub-group is associated with a pre-defined set of parameters.

17. The medium as in claim 16, wherein the parameters are varied based on requirements of the work sub-group.

18. The medium as in claim 14, wherein the steps further comprise:
publishing, through the processor, the comparison onto a user dashboard.

19. The medium as in claim 14, wherein the user dashboard displays the individual productivity measurement as at least one of graph, list, table, chart, map, picture, and pictogram.

20. The medium as in claim 14, wherein a limit for the at least one range is defined by a user of the medium.
